(19) United States
(12) Patent Application Publication
(10) Pub. No.: US 2011/0109819 A1
(43) Pub. Date: May 12, 2011

(54) VIDEO PROJECTOR

(75) Inventor: Yousuke Nishihata, Hirakata-shi (JP)

(73) Assignee: SANYO ELECTRIC CO., LTD., Osaka (JP)

(21) Appl. No.: 12/942,334

(22) Filed: Nov. 9, 2010

(30) Foreign Application Priority Data
Nov. 12, 2009 (JP) 2009-259186

(51) Int. Cl. G02F 1/1335; G03B 21/14

(52) U.S. Cl. 349/5; 353/119

(57) ABSTRACT

A video projector includes a holder for an optical component. The optical component is slid on and coupled to the holder. Frame portions parallel to the sliding direction include slide grooves and a thicknesswise direction clip that presses the optical component in a thicknesswise direction. A lower frame portion includes a rest that receives an end of the optical component. When the end of the optical component reaches the rest, a resilient clip returns to its original form and restricts movement of the optical component in a direction opposite to the sliding direction.

### CROSS-REFERENCE TO RELATED APPLICATIONS

This application is based upon and claims the benefit of priority from prior Japanese Patent Application No. 2009-259186, filed on Nov. 12, 2009, the entire contents of which are incorporated herein by reference.

### BACKGROUND OF THE INVENTION

The present invention relates to a video projector, and more particularly, to a holder for an optical component.

When displaying images onto a large projection surface such as a screen, compact and light projectors have taken over CRT projectors and are now in the mainstream.

One example of such a projector is a liquid crystal display (LCD) projector. A typical LCD projector converts illumination light emitted from a light source into linear polarized light. The polarized light is separated into three colors of light, namely, red light, green light, and blue light. The red, green, and blue lights are respectively projected onto red, green, and blue liquid crystal (LC) light valves. Each LC light valve modulates the corresponding light in accordance with an image signal. The modulated lights are then combined with one another by a dichroic prism and projected onto a screen.

An LCD projector includes an optical system that uses various types of optical components. For example, an LC light valve includes an LCD panel, a polarization plate and optical compensation plate which are arranged in front and behind the LCD panel. The optical system also includes a relay lens and a condenser lens. An optical component is first coupled to a holder (also referred to as an adjustment component). Then, the holder is fixed to a housing, which accommodates the optical system, to couple the optical component to the housing. The use of the holder facilitates replacement and positional adjustments of the optical component.

Japanese Laid-Open Patent Publication Nos. 2008-58674 and 2009-31698 each disclose a monolithic holder. The holder includes a frame having resilient hooks used to hold an optical component. The holder of Japanese Laid-Open Patent Publication No. 2008-58674 will now be described in detail with reference to FIGS. 9(a), 9(b), 9(c) and 10.

As shown in FIGS. 9(a) and 9(b), a condenser lens 110 is coupled to a holder 100. The holder 100 is a monolithic resin molded product and includes a frame 101, which defines an optical path opening through which light from a light source passes. The frame 101 has two corners in which positioning supports 102 are formed. The condenser lens 110 has a lower edge that is fitted into the positioning supports 102. Each positioning support 102 includes a rear tab 102a and a front hook 102b. Further, a hook 104 is formed at a midpoint position between the two positioning supports 102. The hook 104 is arranged to be located on the front surface of the condenser lens 110.

Resilient supports 105 are formed in the remaining two corners of the holder 100. Each resilient support 105 is U-shaped and has a distal end, which forms a hook 106. The hook 106 is resiliently engaged with the upper edge of the condenser lens 110.

The procedures for coupling the condenser lens 110 to the holder 100 will now be discussed. Referring to FIG. 9(a), the lower edge of the condenser lens 110 is first held between the rear tab 102a and front hook 102b of each positioning support 102. Then, as shown by arrow A in FIG. 9(b), the front surface of the condenser lens 110 is pressed to resiliently deform the resilient supports 105 of the holder 100 with the edge of the condenser lens 110.

As shown in FIG. 9(c), when the edge of the condenser lens 110 reaches the hook 106 of each resilient support 105, the condenser lens 110 is snap-fitted to the hook 106. This couples the condenser lens 110 to the holder 100. Arrow B shows the direction of elastic restoring force of the resilient support 105.

The condenser lens 110 may be removed from the holder 100 by releasing the condenser lens 110 from the hooks 106. Such a structure for coupling an optical component may be applied to various types of lenses other than a condenser lens.

FIG. 10 shows further holders 230 and 240 described in Japanese Laid-Open Patent Publication No. 2008-58674. The procedures for coupling an entrance side polarization plate 210 and an optical compensation plate 220 will now be described. Lower ends of the entrance side polarization plate 210 and the optical compensation plate 220 are hooked to hooks 231 and 241 of the holders 230 and 240, respectively. The upper ends of the entrance side polarization plate 210 and the optical compensation plate 220 are pressed against the holders 230 and 240 and engaged with resilient supports 232 and 242, respectively. In this manner, the resilient force from the resilient supports 232 and 242 couple the entrance side polarization plate 210 and the optical compensation plate 220 to the corresponding holders 230 and 240. Levers 233 and 243 are arranged on the holders 230 and 240 to adjust the polarization angles of the entrance side polarization plate 210 and the optical compensation plate 220.

### SUMMARY OF THE INVENTION

However, the inventor of the present invention has noticed that the optical component coupling structure that uses a holder of the prior art has drawbacks. Specifically, when coupling an optical component to the holder of the prior art, optical surfaces of optical components, such as the condenser lens 110, the entrance side polarization plate 210, and the optical compensation plate 220, must be pressed with one's fingers. The pressing direction is substantially the same as the normal direction of the optical surface. Thus, it is difficult for the optical surface of an optical component to avoid contact with a person's fingers. This may result in the optical surface of the optical component being smeared with fingerprints or the like. As a result, the optical surface would adversely affect the quality of the projected image. Further, each resilient support 105 is each U-shaped to be resiliently deformable and has the hook 106 formed on the distal end. Inevitable formation errors in the U-shape and hook 106 may result in the coupling of the optical component being insecure or instable. Further, when a machine is used to couple the optical component to the holder, the optical surface of the optical component may be scratched.

The optical component coupling structure described in Japanese Laid-Open Patent Publication No. 2009-31698 has the same problem as Japanese Laid-Open Patent Publication No. 2009-58674.

One aspect of the present invention is a video projector including a holder having a tetragonal optical path opening through which light passes, in which the holder includes a first frame portion, a second frame portion, a third frame portion, and a fourth frame portion that are formed integrally in correspondence with the four sides of the optical path opening. An optical component is coupled to a coupling surface of the holder by sliding the holder in a sliding direction from the first frame portion of the holder to the second frame portion that is located opposite to the first frame portion. The third and fourth frame portions extend parallel to each other in the sliding direction. The holder further includes a slide groove formed on each of the third and fourth frame portions to receive corresponding side edges of the optical component in a slidable manner. A thicknesswise direction clip is formed on each of the third and fourth frame portions to press the corresponding side edge of the optical component in a thicknesswise direction. A rest is formed on the second frame portion to receive an end of the optical component. A resilient clip is arranged outward from the first frame portion in the sliding direction. The resilient clip is deformed toward a non-coupling surface by a pressing force applied by the optical component when coupling the optical component to the holder. When the optical component reaches a predetermined position, the end of the optical component is received by the rest, the pressing force from the optical component is eliminated, and the resilient clip resiliently returns to its original form thereby restricting movement of the optical component in a direction opposite the sliding direction.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of an optical system in a video projector according to one embodiment of the present invention;

FIG. 2 is a perspective view showing a prism block to which LCD panels, exit side pre-polarization plates, and exit side polarization plates are coupled in the video projector of FIG. 1;

FIG. 3 is a perspective view showing the prism block in a state in which the LCD panel for green light is removed from the state of FIG. 2;

FIG. 4 is an exploded perspective view showing the prism block in a state in which the exit side pre-polarization plate for green light is removed from the state of FIG. 3;

FIG. 5 is an exploded perspective view showing the prism block in a state in which the exit side polarization plate for green light is removed from the state of FIG. 3;

FIG. 6 is a perspective view showing a holder for an exit side pre-polarization plate;

FIG. 7(a) is a perspective view showing the holder with an exit side pre-polarization plate coupled thereto, and FIG. 7(b) is a cross-sectional view taken along line 7b-7b in FIG. 7(a);

FIG. 8(a) is a perspective view showing the holder of FIG. 6, FIG. 8(b) is a cross-sectional view taken along line 8b-8b in FIG. 8(a), and FIG. 8(c) is a cross-sectional view taken along line 8c-8c in FIG. 8(b);

FIG. 9(a) is a perspective view showing a holder of the prior art, FIG. 9(b) is a perspective view of the holder with a condenser lens coupled thereto, and FIG. 9(c) is an enlarged view showing a resilient support of the holder; and

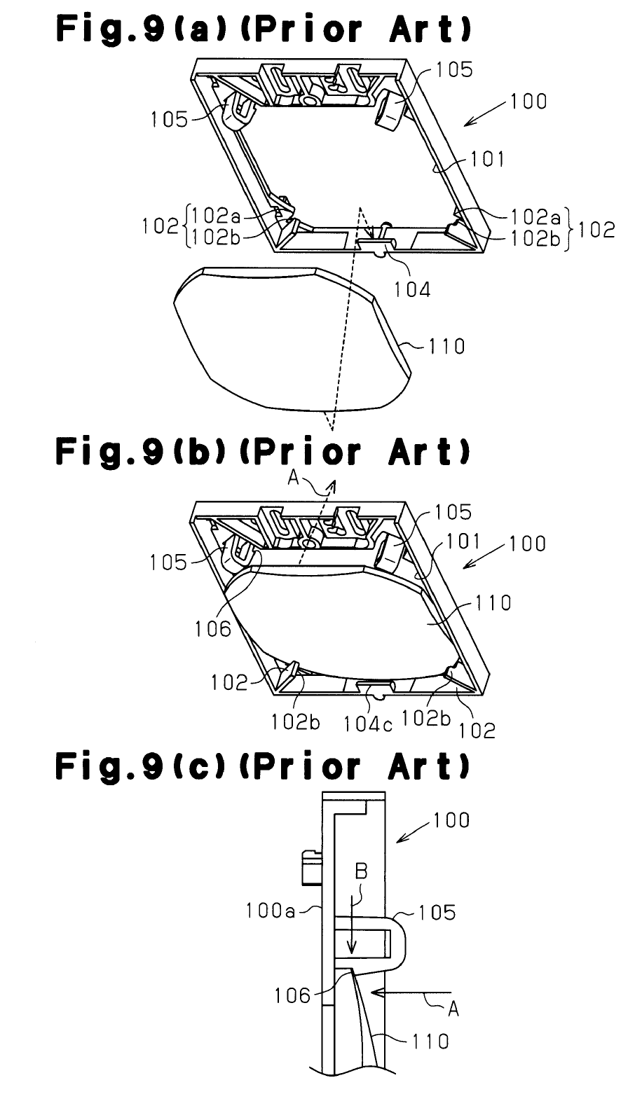

FIG. 10 is a perspective view showing a polarization plate and an optical compensation plate coupled to holders of the prior art.

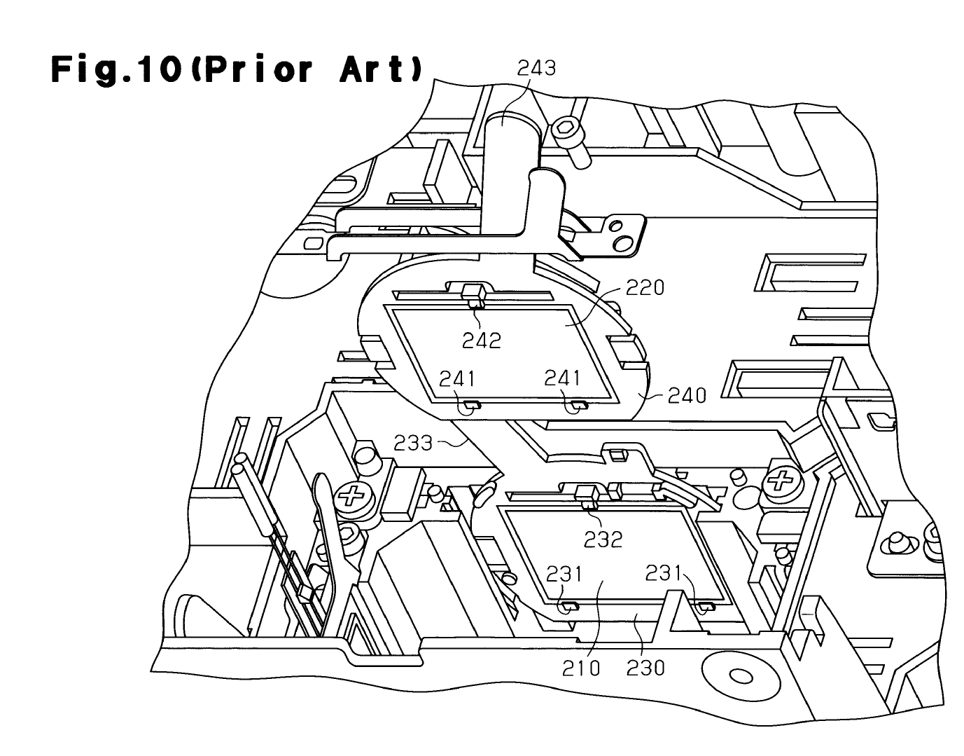

### DETAILED DESCRIPTION OF THE INVENTION

A video projector serving as an electronic device according to a preferred embodiment of the present invention will now be discussed with reference to the drawings. In the description hereafter, the terms front, rear, left, right, up, and down, are used to describe components or positions and directions relative to such components and are not used to limit positions and directions during use of the electronic device.

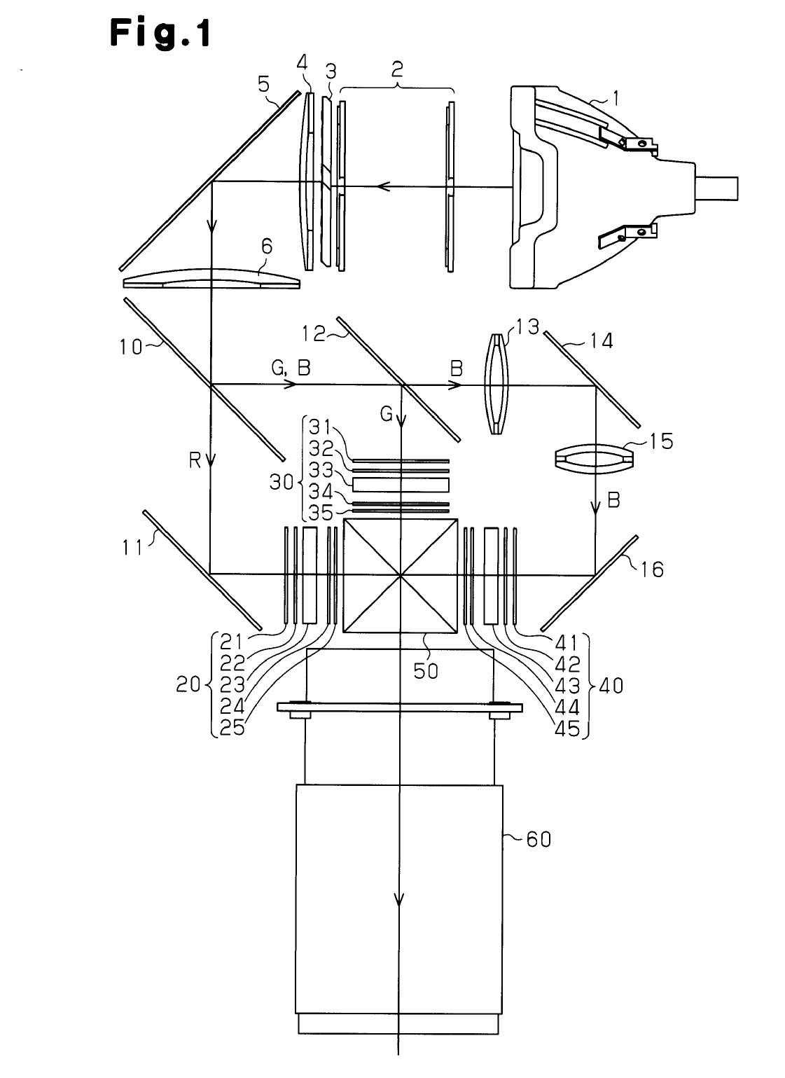

An optical system of the video projector will now be described with reference to FIG. 1. The video projector of the present embodiment is a so-called three-chip LCD projector. A light source 1 includes a light emitting element using a discharge lamp such as a metal halide lamp and an ultra-high pressure mercury vapor lamp. The light source 1 may include a reflector that adjusts light emitted from the light emitting element to parallel light. The light emitted from the light source 1 travels to an integrator lens 2, a polarization conversion element 3, a condenser lens 4, a reflection mirror 5, and a relay lens 6 and then strikes a first dichroic mirror 10. The integrator lens 2 includes, for example, two fly's eye lenses. Each fly's eye lens includes lens portions, each formed to entirely illuminate LC light valves 20, 30, and 40, with the light emitted from the light source 1. The integrator 2 functions to eliminate partial illuminance variations thereby obtaining uniform illuminance in the light emitted from the light source 1. This decreases the difference in the amount of light between the central portion and peripheral portion of a screen.

The first dichroic mirror 10 transmits red light (R) and reflects green light (G) and blue light (B) to separate the red light (R) from the green light (G) and blue light (B). The red light travels to a reflection mirror 11 and then enters a red light LC light valve 20. A second dichroic mirror 12 reflects the green light and transmits the blue light to separate the blue light (B) from the green light (G). The green light enters a green light LC light valve 30. The blue light travels to a relay lens 13, a reflection mirror 14, a relay lens 15, and a reflection mirror 16 and then enters a blue light LC light valve 40. The red, green, and blue LC light valves 20, 30, and 40 include entrance side polarization plates 21, 31, and 41, entrance side optical compensation plates 22, 32, and 42, LCD panels 23, 33, and 43 serving as light modulation elements, exit side pre-polarization plates 24, 34, and 44, and exit side polarization plates 25, 35, and 45, respectively. A cross dichroic prism 50 combines the red light, green light, and blue light modulated by the LC light valves 20, 30, and 40 and provides a projection system 60 with the combined light.

Optical components such as the entrance side polarization plates 21, 31, and 41, the entrance side optical compensation plates 22, 32, and 42, the exit side pre-polarization plates 24, 34, and 44, the exit side polarization plates 25, 35, and 45, the condenser lens 4, the relay lens 6, 13, and 15 may each be arranged in an optical path of an optical system in a state coupled to an optical component holder (hereinafter simply referred to as the holder).

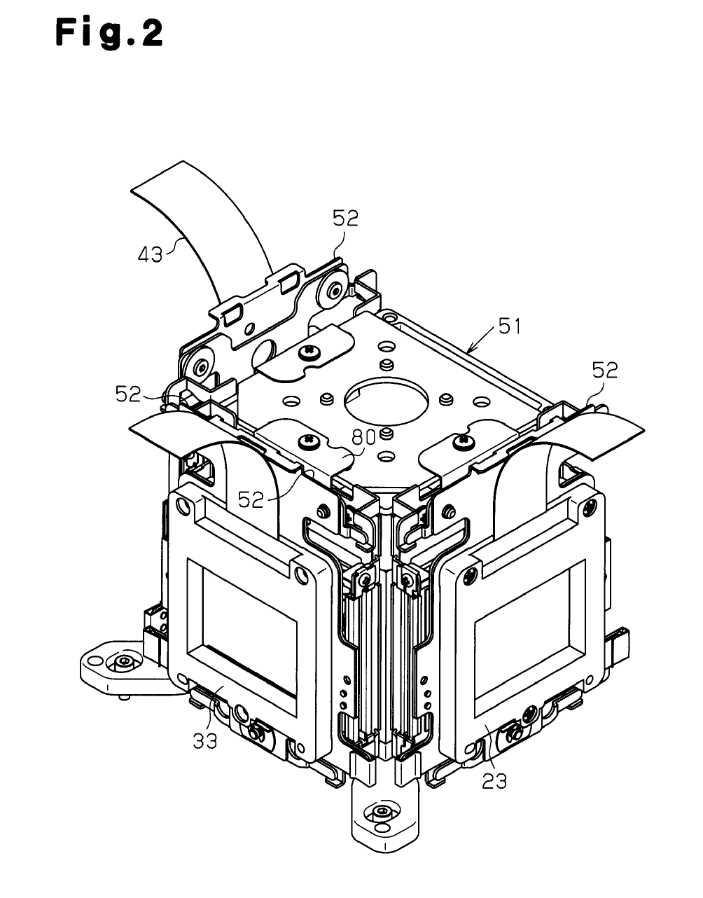

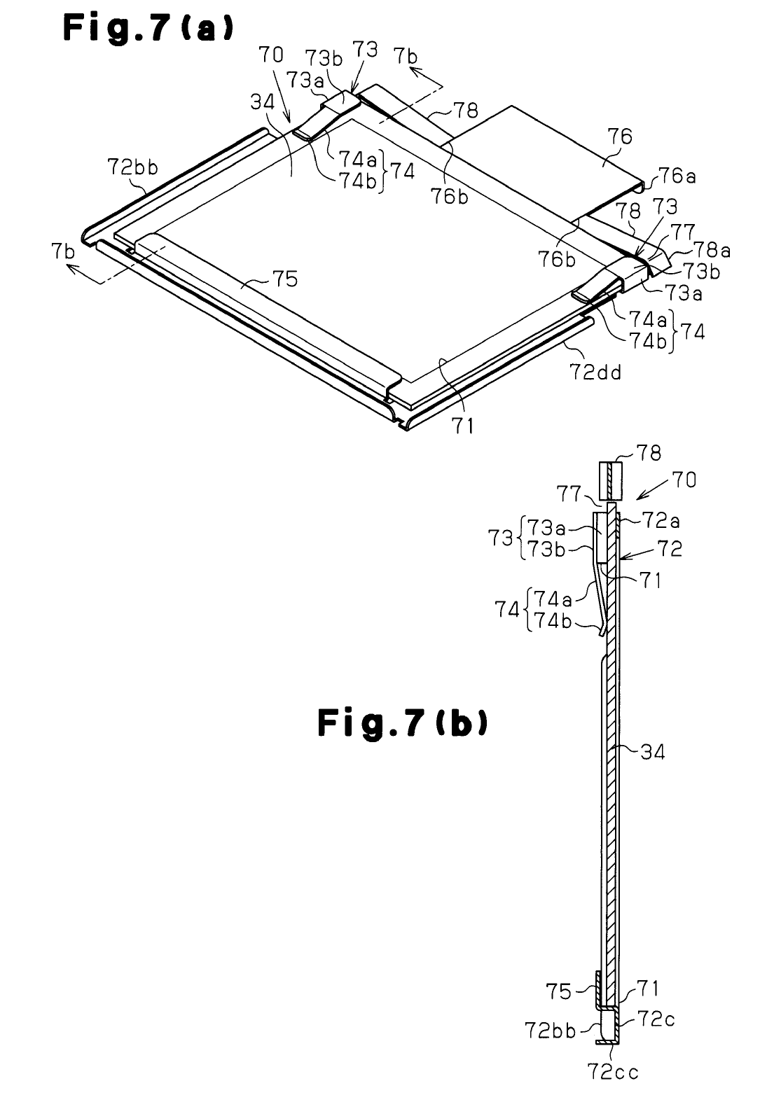

The structure of the holder and the coupling of the optical components to the holder will now be discussed. As a representative example, the structure of the holder for the exit side pre-polarization plate 34 will be described with reference to FIGS. 2 to 8.

As shown in FIG. 2, a prism block 51 includes entrance surfaces in three directions. The LCD panels 23, 33, and 43, the exit side pre-polarization plates 24, 34, and 44, and the exit side polarization plates 25, 35, and 45 are coupled to the entrance surfaces of the three directions, respectively.

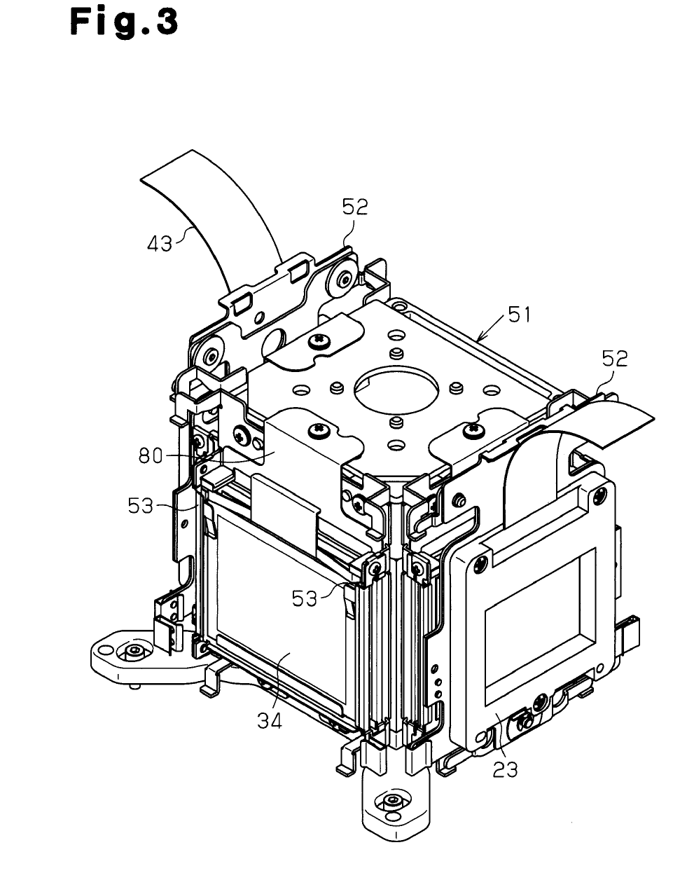

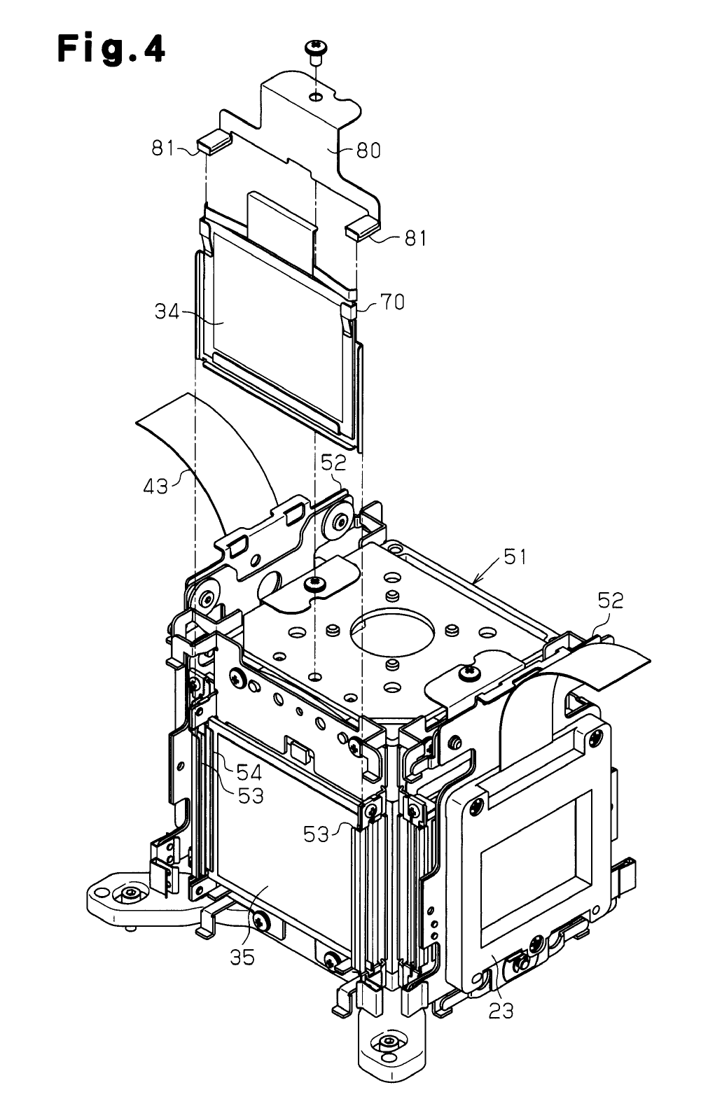

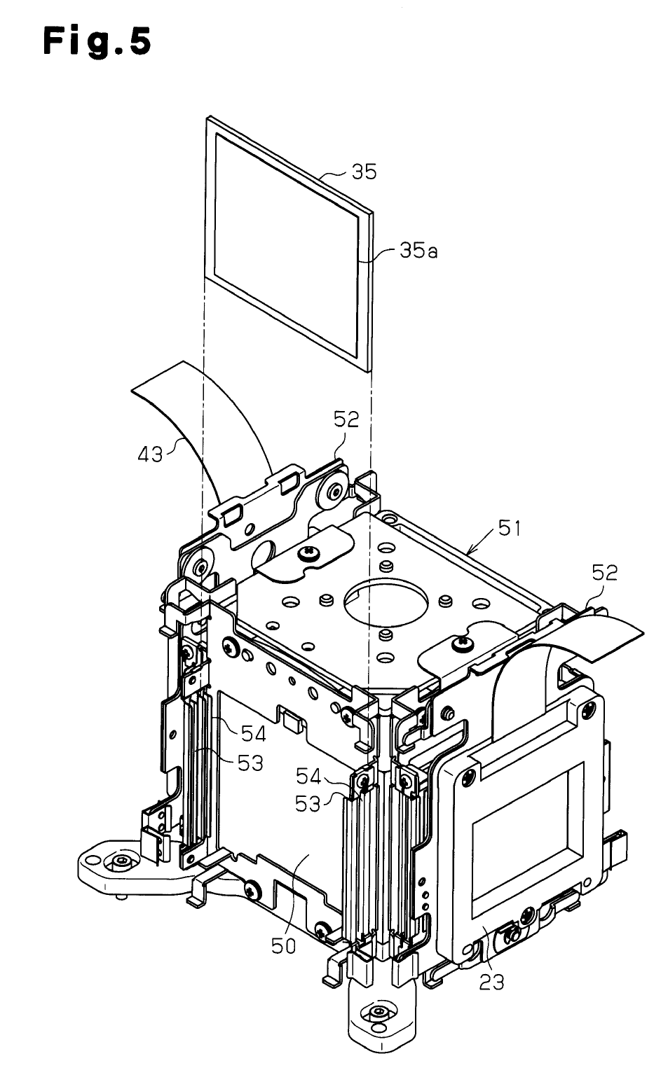

Referring to FIGS. 2 and 3, the LCD panels 23, 33, and 43 are each soldered and fixed to the prism block 51 by way of a flat coupling plate 52. As shown in FIG. 4, the exit side pre-polarization plate 34 is inserted into two vertical grooves 53, which are formed in the prism block 51 at the exit side of the LCD panel 33. As shown in FIG. 5, the exit side polarization plate 35 is directly inserted into two vertical grooves 54, which are formed in the prism block 51 at the exit side of the exit side pre-polarization plate 34. A downward extending fastener 80 restricts upward movement of the holder 70 and the exit side polarization plate 35, which are inserted into the vertical grooves 53, and 54. This prevents upward removal of the holder 70 and the exit side polarization plate 35. Sponge-like pads 81 are arranged on the downward extending fastener 80 so as to be located above the holder 70 and top end face of the exit side polarization plate 35.

As shown in FIG. 1, the entrance side polarization plates 21, 31, and 41 and the entrance side optical compensation plates 22, 32, and 42 are coupled to the entrance side of the LCD panels 23, 33, and 43 (closer to the light source 1). These components are not shown in FIGS. 2 to 8.

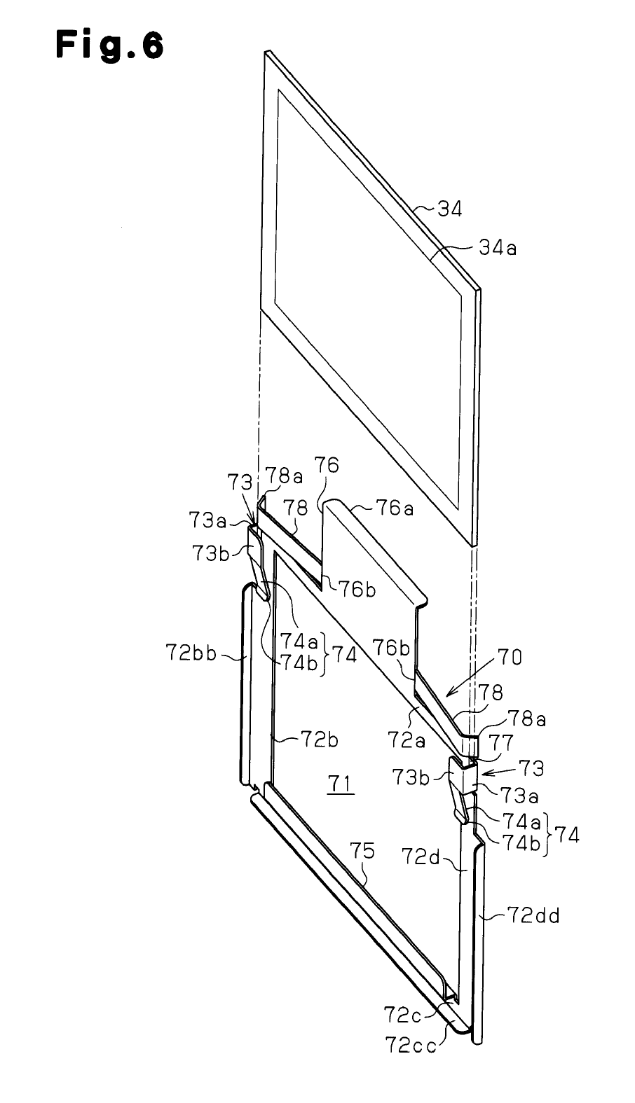

The exit side pre-polarization plate 34 may be an aluminum vapor-deposition polarization plate. The exit side pre-polarization plate 34 is manufactured by vapor-depositing a plurality of aluminum strips in predetermined intervals on an optical surface of a tetragonal glass substrate and forming an aluminum vapor-deposition region 34a (refer to FIG. 6). The exit side polarization plate 35 may be a polarization plate to which a resin film 35a (refer to FIG. 5) is adhered.

Referring to FIGS. 6 to 8, the holder 70 includes frame portions 72a, 72b, 72c, and 72d respectively corresponding to the four sides of a tetragonal optical path opening 71. The holder 70 may be formed from a single sheet of stainless steel. The exit side pre-polarization plate 34 is slid along a coupling surface of the holder 70 from the upper frame portion 72a to the lower frame portion 72c. This couples the exit side pre-polarization plate 34 to the holder 70. The coupling surface of the holder 70 (particularly, the frame portions 72a, 72b, 82c, and 72d) may be referred to as an entrance side surface or a front surface. The surface opposite to the coupling surface may be referred to as a non-coupling surface, an exit side surface, or a rear surface.

The holder 70 has a slide groove 73 and a thicknesswise direction clip 74 formed on the left frame portion 72b and on the right frame portion 72d. The two slide grooves 73 slidably receive two opposite edges of the exit side pre-polarization plate 34. Each thicknesswise direction clip 74 presses the exit side pre-polarization plate 34 in the thicknesswise direction. The left frame portion 72b and the right frame portion 72d each have an outer end bent toward the front, or the entrance side, from the coupling surface to form bent pieces 72bb and 72dd. The slide grooves 73 each define an optical component insertion slot.

Each slide groove 73 has a cornered C-shaped cross-section. In the illustrated example, each slide groove 73 includes a side wall 73a and a wall portion 73b. The side wall 73a is formed by bending the coupling surface at a right angle. The wall portion 73b is formed by bending the side wall 73a at a right angle parallel to the coupling surface. The left and right ends of the exit side pre-polarization plate 34 are inserted into and moved downward along the slide grooves 73. This slides the exit side pre-polarization plate 34 downward along the coupling surface of the holder 70. After sliding the exit side pre-polarization plate 34 downward, the top face and bottom face of the exit side pre-polarization plate 34 are supported. In this manner, the exit side pre-polarization plate 34 is easily coupled to the holder 70. As shown in the drawings, the left frame portion 72b and the right frame portion 72d may be elongated plates extending parallel to the sliding direction (downward direction). The upper frame portion 72a and the lower frame portion 72c may be elongated plates extending perpendicular to the sliding direction. The side wall 73a of the slide groove 73 may be referred to as a lateral direction restriction portion that restricts movement of the exit side pre-polarization plate 34 in the leftward and rightward directions.

The thicknesswise direction clips 74 face toward the coupling surface on the frame portions 72b and 72d. The coupling surface functions as one inner surface of the slide grooves 73. Each thicknesswise direction clip 74 is formed integrally with the wall portion 73b, which also functions as one inner surface of the corresponding slide groove 73. The thicknesswise direction clips 74 each include a pressing piece 74a and a curved portion 74b. The pressing piece 74a, which extends in the sliding direction from the wall portion 73b of the corresponding slide groove 73, faces toward the coupling surface of the corresponding one of the frame portions 72b and 72d. Further, the pressing piece 74a is formed so that the distance from the coupling surface of the corresponding one of the decreases in the sliding direction. The pressing piece 74a resiliently presses the exit side pre-polarization plate 34 in the thicknesswise direction. The curved portion 74b is formed on the distal end of the pressing piece 74a and extends away from the coupling surface of the corresponding one of the frame portions 72b and 72d. The distance between the curved portion 74b and the coupling surface of the corresponding one of the frame portions 72b and 72d is slightly smaller than the thickness of the coupling subject, namely, the exit side pre-polarization plate 34. The thicknesswise direction clips 74 press the exit side pre-polarization plate 34 at the outer side of the aluminum vapor-deposition region 34a. Thus, the thicknesswise direction clips 74 do not adversely affect the performance of the exit side pre-polarization plate 34.

The lower frame portion 72c of the holder 70 includes a rest 75 to receive the lower end of the exit side pre-polarization plate 34. The lower frame portion 72c has a lower end bent toward the front from the coupling surface to form a bent piece 72cc.

A plate-shaped lug 76 is formed on an upper portion of the upper frame portion 72a. The lug 76 has an upper end bent toward the exit side, or the rear, to form a catch 76a.

Resilient clips 78 extend toward the left and right from the lug 76. Each resilient clip 78 may be a leaf spring. The resilient clips 78 are spaced apart by a clearance 77, which has a relatively small and fixed dimension, from the top end face of the upper frame portion 72a. Further, the resilient clips 78 extend diagonally toward the front relative to the plane of the lug 76. In the illustrated example, the resilient clips 78 each have bent basal ends.

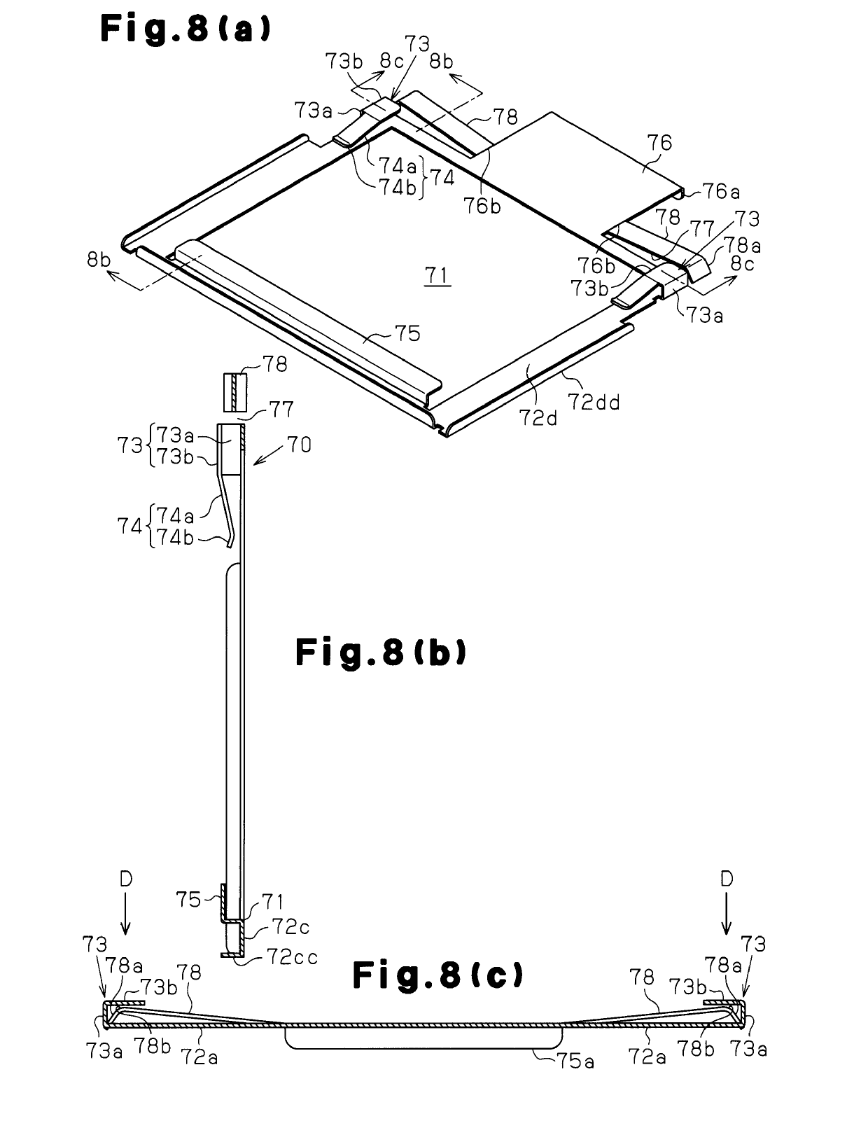

Each resilient clip 78 has a distal portion bent toward the rear to form a bent part 78a. When each bent part 78a is pressed toward the rear (in the direction indicated by arrows D in FIG. 8(c)), the corresponding resilient clip 78 is resiliently deformed with ease toward the rear about a boundary 76b with the lug 76. When the pressing force is released, the resilient clip 78 returns to its original state (initial state shown in FIG. 8(c)). The dimension from the bottom end face of each resilient clip 78 to the rest 75 conforms to the vertical dimension of the exit side pre-polarization plate 34. As a result, the bottom end face of each resilient clip 78 abuts against the top end face of the exit side pre-polarization plate 34 and restricts upward movement of the exit side pre-polarization plate 34. When coupling the exit side pre-polarization plate 34 to the holder 70, the resilient clips 78 have contact portions 78b (refer to FIG. 8C)) that contact the exit side pre-polarization plate 34. However, the contact portions 78b are formed to contact frame portions located outward from the aluminum vapor-deposition region 34a of the exit side pre-polarization plate 34. Thus, the resilient clips 78 do not adversely affect the performance of the exit side pre-polarization plate 34.

The procedures for coupling the exit side pre-polarization plate 34 to the holder 70 will now be discussed. As shown in FIG. 6, the exit side pre-polarization plate 34 is arranged above the holder 70, in particular, above the lug 76. It is preferable that end faces of the exit side pre-polarization plate 34 be held with one's fingers so that the fingers do not contact the optical plane of the exit side pre-polarization plate 34. Then, the left and right bottom end portions of the exit side pre-polarization plate 34 are inserted into the two slide grooves 73 while pressing the bent parts 78a of the resilient clips 78 toward the side of the non-coupling surface, as indicated by the arrows D in FIG. 8(c), with the frame of the exit side pre-polarization plate 34. The exit side pre-polarization plate 34 is slid downward until its bottom end face abuts against the rest 75. This releases the bent parts 78a from the pressing force applied by the exit side pre-polarization plate 34. Abutment of the top end face of the exit side pre-polarization plate 34 against the bottom end faces of the resilient clips 78 restricts upward movement of the exit side pre-polarization plate 34. In this manner, the exit side pre-polarization plate 34 is coupled to the holder 70 at a predetermined position.

The procedures for removing the exit side pre-polarization plate 34 from the holder 70 will now be discussed. First, the exit side pre-polarization plate 34 is lifted while pressing the bent parts 78a of the resilient clips 78 toward the non-coupling surface at the top end of the exit side pre-polarization plate 34. Then, the exit side pre-polarization plate 34 is further lifted while pressing the bent parts 78a toward the side of the non-coupling surface. This removes the exit side pre-polarization plate 34 from the holder.

The above-discussed embodiment has the advantages described below.

(1) The exit side pre-polarization plate 34 is slid in the sliding direction while pressing the resilient clips 78 toward the side of the non-coupling surface to couple the exit side pre-polarization plate 34 to the holder 70. When removing the exit side pre-polarization plate 34 from the holder 70, the resilient clips 78 are deformed toward the non-coupling surface with the fingertips to move the exit side pre-polarization plate 34 in the direction opposite to when it was coupled to the holder 70. Accordingly, the exit side pre-polarization plate 34 may be easily coupled to and removed from the holder 70 without the optical surface of the exit side pre-polarization plate 34 being smeared with fingerprints or the like. The resilient clips 78, rest 75, and slide grooves 73 of the holder 70 restrict upward, downward, leftward, and rightward movement of the exit side pre-polarization plate 34. The thicknesswise direction clips 74 of the holder 70 resiliently press the exit side pre-polarization plate 34 in the thicknesswise direction. Thus, the exit side pre-polarization plate 34 is securely and stably coupled to the holder 70. The use of the thicknesswise direction clips 74 is not limited to a single optical component such as the exit side pre-polarization plate 34. The thicknesswise direction clips 74 are also effective for supporting an optical component formed by a plurality of laminar parts.

(2) When forming the holder 70, there is no need to provide hooks, which would result in formation errors as in the prior art. This securely and stably couples the exit side pre-polarization plate 34 to the holder 70.

(3) Each slide groove 73 has a cornered C-shaped cross-section to serve as a restriction member that restricts movement of the exit side pre-polarization plate 34 in the leftward and rightward directions. This simplifies the structure of the holder 70.

(4) Each thicknesswise direction clip 74 includes the pressing piece 74a, which faces toward the coupling surface of the corresponding one of the frame portions 72b and 72d and extends in the sliding direction. The pressing piece 74a is formed so that the distance from the coupling surface of the corresponding ones of the frame portions 72b and 72d decreases in the sliding direction. Further, the pressing piece 74a resiliently presses the exit side pre-polarization plate 34 in the thicknesswise direction. Such a thicknesswise direction clip 74 guides the coupling of the exit side pre-polarization plate 34 to the holder 70. This facilitates the sliding and coupling of the exit side pre-polarization plate 34.

(5) In each thicknesswise direction clip 74, the curved portion 74b, which is formed on the distal end of the pressing piece 74a, is bent away from the coupling surface of the corresponding one of the frame portions 72b and 72d. Thus, when removing an optical component from the holder 70, the optical surface of the optical component is not damaged by the distal end of the thicknesswise direction clip 74.

(6) The pressing piece 74a of the thicknesswise direction clip 74 is formed integrally with and extends from the wall portion 73b, which functions as one inner surface of the corresponding slide groove 73. This facilitates formation of the resiliently deformable pressing piece 74a.

(7) The holder 70 includes the lug 76, which is located outward from the upper frame portion 72a. The two resilient clips 78 extend toward the left and right from the lug 76 in a state spaced apart by the clearance 77 from the upper frame portion 72a. Each resilient clip 78 extends diagonally relative to the plane of the lug 76. The distal ends of the two resilient clips 78 extend to the outer ends of the frame portions 72b and 72d and are located at the coupling surface side of the exit side pre-polarization plate 34. When coupling the exit side pre-polarization plate 34 to the holder 70, the exit side pre-polarization plate 34 presses the resilient clips 78 toward the non-coupling surface side of the holder 70. When the exit side pre-polarization plate 34 reaches a predetermined position, the pressing force is released, and the resilient clips 78 return to their original form. As a result, the resilient clips 78 abut against the top end face of the exit side pre-polarization plate 34. This restricts movement of the exit side pre-polarization plate 34 in a direction opposite to the sliding direction (upward direction). In this manner, the resilient clips 78 are easily resiliently deformed when coupling and removing the exit side pre-polarization plate 34. The coupling of the exit side pre-polarization plate 34 is performed through a simple operation in which the exit side pre-polarization plate 34 is pressed in the sliding direction.

(8) The distal end of the lug 76 is bent toward the side of the non-coupling surface to form the catch 76a. The catch 76a does not interfere with the sliding and coupling of the exit side pre-polarization plate 34. Positional adjustment of the holder 70 in addition to the coupling and removal of the holder 70 may be easily performed by gripping the catch 76a.

(9) The holder 70 is used to couple the exit side pre-polarization plate 34, which requires position adjustments. Further, the exit side pre-polarization plate 34 is most exposed to high temperatures among the optical components and is thereby replaced more often than the other components. Accordingly, the use of the holder 70 is convenient for such an application.

(10) The holder 70 is a monolithic product formed by bending a sheet of stainless steel. Stainless steel has heat resistance and high resiliency. Thus, stainless steel is optimal when used to form the holder 70 for an exit side polarization plate.

It should be apparent to those skilled in the art that the present invention may be embodied in many other specific forms without departing from the scope of the invention. Particularly, it should be understood that the present invention may be embodied in the following forms.

In the above-discussed embodiment, the exit side pre-polarization plate 34 is described as a representative optical component arranged in the optical path of green light. However, the holder 70 may also be used to couple the exit side polarization plate 35 or the LCD panel 33. The holder 70 may be used to hold solely or in combination the exit side pre-polarization plates 24 and 44, the LCD panels 23 and 43, and the exit side polarization plates 25 and 45 that are arranged in the optical paths for the lights of other colors. The use of the holder 70 in such a manner obtains the same advantages as the above-discussed embodiment.

The use of the holder 70 is not limited to the optical components located in the vicinity of LCD panels and may also be used to couple the condenser lens 4, the relay lenses 6, 13, and 15, and the like. This obtains the same advantages as the above-discussed embodiment. When coupling a lens system such as that described above, a holder 70 that does not have the lug 76 may be used.

In the above-discussed embodiment, the holder 70 is configured to hold a single optical component. However, a plurality of optical components may be coupled to the holder 70. For example, a polarization film formed by applying a plurality of films to one side of a glass substrate may be coupled to the holder 70. In this case, when the films are hard and thick enough, the films need not be adhered to the glass substrate in a state superimposed with one another. Further, an optical component formed by adhering polarization films to opposite sides of a glass substrate may be coupled to the holder 70.

In the above-discussed embodiment, stainless steel is used as the material for the holder 70. However, a heat resistant resin may also be used as the material for the holder 70.

In addition to forming the slide grooves 73 in the upper ends of the left frame portion 72b and the right frame portion 72d, one or more side walls 73a may be formed at locations separated from the top end of the frame portions 72b and 72d. In this case, displacement of an optical component in the lateral direction is further strictly restricted.

The thicknesswise direction clips 74 may be arranged at a plurality of locations on the frame portions 72b and 72d. For example, the thicknesswise direction clips 74 may be arranged on the upper and lower parts of the frame portions 72b and 72d. This is preferable since a plurality of polarization plates may be uniformly pressed.

In addition to being applied to various types of video projectors, the holder 70 may be applied to various types of electronic devices. For example, in the above-discussed embodiment, the holder 70 is applied to a three-chip LCD projector. However, the holder 70 may be applied to a projector including other image light generation systems or a projector employing DIGITAL LIGHT PROCESSING (DLP, registered trademark owned by Texas Instruments) technology.

The present examples and embodiments are to be considered as illustrative and not restrictive, and the invention is not to be limited to the details given herein, but may be modified within the scope and equivalence of the appended claims.

What is claimed is:

1. A video projector comprising:
a holder having a tetragonal optical path opening through which light passes, in which the holder includes a first frame portion, a second frame portion, a third frame portion, and a fourth frame portion that are formed integrally in correspondence with the four sides of the optical path opening; and
an optical component coupled to a coupling surface of the holder by sliding the holder in a sliding direction from the first frame portion of the holder to the second frame portion that is located opposite to the first frame portion;
wherein the third and fourth frame portions extend parallel to each other in the sliding direction; and
the holder further including:
a slide groove formed on each of the third and fourth frame portions to receive corresponding side edges of the optical component in a slidable manner;
a thicknesswise direction clip formed on each of the third and fourth frame portions to press the corresponding side edge of the optical component in a thicknesswise direction;
a rest formed on the second frame portion to receive an end of the optical component; and
a resilient clip arranged outward from the first frame portion in the sliding direction;
wherein the resilient clip is deformed toward a non-coupling surface by a pressing force applied by the optical component when coupling the optical component to the holder; and
when the optical component reaches a predetermined position, the end of the optical component is received by the rest, the pressing force from the optical component is eliminated, and the resilient clip resiliently returns to its original form thereby restricting movement of the optical component in a direction opposite the sliding direction.

2. The video projector according to claim 1, wherein the slide groove has a cornered C-shaped cross-section to form a lateral direction restriction portion that restricts movement of the optical component in a direction perpendicular to the sliding direction.

3. The video projector according to claim 1, wherein the thicknesswise direction clip includes a pressing piece extending in the sliding direction and facing toward the coupling surface; and
the pressing piece is spaced apart from the corresponding coupling surface by a distance that decreases in the sliding direction so as to resiliently press the optical component in the thicknesswise direction.

4. The video projector according to claim 3, wherein the thicknesswise direction clip includes a curved portion that extends away from the corresponding coupling surface at a distal end of the pressing piece.

5. The video projector according to claim 3, wherein the thicknesswise direction clip integrally includes the pressing piece and a wall portion facing toward the coupling surface that functions as one inner surface of the slide groove, with the pressing piece extending from the wall portion.

6. The video projector according to claim 3, wherein the holder further includes a lug arranged outward from the first frame portion;
the resilient clip diagonally extends from opposite sides of the lug toward outer ends of the third and fourth frame portions and is spaced apart by a clearance from the first frame portion;
the resilient clip has a distal portion pressed by the optical component toward the side of the non-coupling surface when coupling the optical component to the holder; and
when the optical component reaches the predetermined position, the optical component stops pressing the distal portion of the resilient clip and resiliently returns the resilient clip to its original form, with part of the resilient clip facing toward the first frame portion abutting against an end face of the optical component and restricting movement of the optical component in the direction opposite to the sliding direction.

7. The video projector according to claim 6, wherein the lug has a distal end bent toward the side of the non-coupling surface to form a catch.

8. The video projector according to claim 1, wherein the optical component is a polarization plate arranged at an exit side of an LCD panel serving as a light modulation element.

9. The video projector according to claim 8, wherein the polarization plate is an aluminum vapor-deposition polarization plate formed by depositing aluminum on a glass substrate.

10. The video projector according to claim 9, wherein the holder is a monolithic product formed by bending a shingle sheet of stainless steel.

11. The video projector according to claim 1, wherein the slide groove defines an optical component insertion slot; and
the resilient clip when in the original form covers at least part of the optical component insertion slot.

12. The video projector according to claim 1, wherein the holder is incorporated in the video projector in a state holding the optical component.
